(19) United States
(12) Patent Application Publication
(10) Pub. No.: US 2019/0221107 A1
(43) Pub. Date: Jul. 18, 2019

(54) In-vehicle Infotainment System Emergency Lighting and Siren Application and In-vehicle Emergency Call-Log Application

(71) Applicant: Douglas Charles Miller, JR., Franklin, MI (US)

(72) Inventor: Douglas Charles Miller, JR., Franklin, MI (US)

(21) Appl. No.: 16/139,094

(22) Filed: Sep. 23, 2018

Related U.S. Application Data
(60) Provisional application No. 62/617,283, filed on Jan. 14, 2018.

(51) Int. Cl. G08B 27/00; B60Q 1/52; B60K 35/00; G08G 1/0968; G08G 1/0969; G08G 1/0967; G08G 1/00; G08B 25/10

(52) U.S. Cl. CPC G08B 27/001; B60Q 1/525; B60K 35/00; G08G 1/096805; G08G 1/0969; B60K 2350/2026; G08G 1/202; G08B 25/10; B60K 2350/1096; B60K 2350/1028; G08G 1/096775

(57) ABSTRACT

A system and method for Original Equipment Manufacturer (OEM) hard wired in-vehicle infotainment system software or firmware, Emergency Lighting and Siren Application, to activate all emergency lighting and sirens, using only OEM communication networks and OEM modules, while maintaining OEM operation that meets lighting and control functions in accordance with the National Highway and Safety and Transportation Administration (NHSTA) Federal Motor Vehicle Safety Standards (FMVSS) and Electronic Code of Federal Regulations (e-CFR).

### BACKGROUND

Disclosed application claims the benefit of U.S. Provisional Application No. 62/617,283, filed Jan. 14, 2018.

Recent advancements in OEM In-vehicle Infotainment Systems have made it possible for improved methods and systems for emergency lighting and siren controls. These improved control methods allow for specially designed In-vehicle Infotainment firmware or software to incorporate emergency lighting and siren functionality into emergency vehicles, all while operating exclusively with OEM wired modules, over OEM communication networks comprised of a Local Interconnect Network (LIN), High Speed CAN (HSCAN), Low Speed CAN (LSCAN), Infotainment CAN (InfoCAN) or any other OEM CAN bus network.

By a unique Graphic User Interface (GUI) made exclusively for an In-vehicle Infotainment System, data outputs to control pulse signal, voltage, current or amperage can be sent to an Infotainment System Network, Gateway Module (GWM), or any other OEM equipped module to operate an OEM light, emergency light or siren. This enhanced control method allows for compliance with National Highway and Safety and Transportation Administration (NHSTA) Federal Motor Vehicle Safety Standards (FMVSS) and Electronic Code of Federal Regulations (e-CFR).

Eliminating existing add-ons, like external non-OEM controllers reduce the total purchase price of an emergency vehicle and standardizes wiring for emergency controls, eliminating variability that can lead to vehicle down-time. Additionally, the vehicle will have more useable space available as peripheral mounting for non-OEM modules will be eliminated, which also reduces the Gross Vehicle Weight Rating (GVWR).

Additional benefits from the In-vehicle Infotainment System Emergency Lighting and Siren Application is the ability to record emergency lighting and siren functionality and activation via an event data recorder (EDR), which communicates over the vehicle's OEM CAN bus network, from inputs received from the firmware or software. This improved system enables vehicle owners to legally contest claims pertaining to accidents where lighting and siren activation and functionality are in question.

### SUMMARY

The following is a brief summary of subject matter that is described in greater detail herein. This summary is not intended to be limiting as to the scope of the claims.

The Infotainment System Emergency Lighting and Siren Application will control all emergency lighting and sirens equipped on a vehicle and include an emergency home screen on the GUI, allowing the user to operate both the emergency lighting and sirens after initial configurations have been pre-set. Much like a push-button hand controller, currently used to operate the pre-programed functionality, the In-vehicle Infotainment Emergency Lighting and Siren Application will now control lighting and siren functionality.

A further embodiment method includes using the in-vehicle infotainment system to transmit an input to an OEM module, such as the Gateway Module (GWM), Body Control Module (BCM), Powertrain Control Module (PCM), Transmission Control Module (TCM) or any other OEM module for the purposes of adjusting pulse signal, voltage, current or amperage to an OEM light. Modification of the pulse signal, voltage, current or amperage allows for the OEM lighting to be utilized as emergency lighting for additional functionality, such as strobe, light color, flash pattern, etc. Utilizing the improved method ensures compliance with the National Highway and Safety and Transportation Administration (NHSTA) Federal Motor Vehicle Safety Standards (FMVSS) and Electronic Code of Federal Regulations (e-CFR).

A further embodiment method includes a GUI capable of displaying a visual depiction of the vehicle with emergency lights in operation, to test pattern configuration, which can be reconfigured from the In-vehicle Infotainment System GUI. Visual depiction on the GUI will allow the user to view and configure the emergency lighting from a forward facing vehicle, displaying the front, right hand side, left hand side, top and rear view. Changes to the configuration include, but are not limited to turning lights on or off, lighting flash patterns, light color, light directional indicators, light bulb pulse, park, turn or strobe. Changes to the siren sound will also be configurable from a separate siren configuration screen on the GUI.

### BRIEF DESCRIPTION OF THE DRAWINGS

FIG. 1 is the functional block diagram of an exemplary system that facilitates the communication network for an In-vehicle Emergency Light and Siren Application.

FIG. 2 is a mockup of the Emergency Lighting and Siren Application with a Graphic User Interface (GUI) for a Home screen used to control all emergency lighting and siren controls.

FIG. 3 is a mockup of the Emergency Lighting and Siren Application with a Graphic User Interface (GUI) of all emergency lighting equipped on the vehicle in the front view.

FIG. 4 is a mockup of the Emergency Lighting and Siren Application with a Graphic User Interface (GUI) of the light bar display to change individual lights ON/OFF, light color, light sequence and light flash pattern.

FIG. 5 is a flow diagram that illustrates an exemplary methodology for an Infotainment System Emergency Lighting and Siren Application data transmission process flow.

FIG. 6 is a functional block diagram that illustrates the Emergency Lighting and Siren Application methodology in a computing embodiment.

### DETAILED DESCRIPTION

The following detailed description illustrates exemplary embodiments by way of example for the present disclosure herein. In-vehicle Infotainment System Emergency Lighting and Siren Application is now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

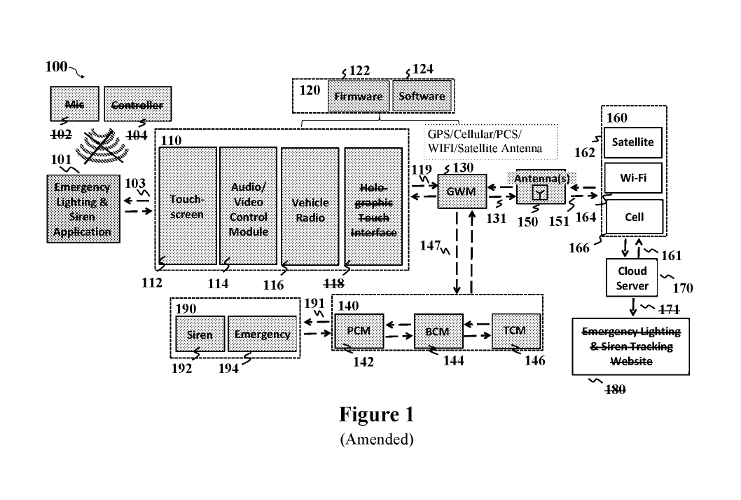

With reference to FIG. 1, an exemplary system 100 that facilitates a Graphical User Interface (GUI) of viewing and adjusting vehicle emergency lighting and siren onto an infotainment system, used to display vehicle positioning is illustrated. In one embodiment the Emergency Lighting and Siren Application interface 101 receives or sends an input and output signal 103. Input and output signal 103 are sent to or from the infotainment system network 110, which includes a Touchscreen 112, Audio and Video Control Module (AVCM) 114 and Vehicle Radio 116. The Touchscreen 112 and AVCM 114 has two functions: an in-dash touchscreen input to select from one of the input signals, and an audio and video control function. In one embodiment, an AVCM 114 is a separate function from the Touchscreen 112: in other words, the infotainment system interface represents an in-dash Touchscreen 112 input only. In another embodiment, the Vehicle Radio 116 is used in conjunction with a Touchscreen 112. In yet another embodiment, the vehicle radio 116 is used in conjunction with an AVCM 114.

The network 120 includes a firmware 122 and software 124 for download onto one or more of the embodiments in the infotainment system network 110. Function of network 120 will include a method to adjust emergency lighting and siren including turning lights on or off, changing lighting flash patterns, light color, light directional indicators, light bulb pulse, park, turn, strobe and adjusting sounds out of the siren. Firmware 122 or software 124 will also include a transmission method to recognize when emergency lighting is activated.

The Gateway Module (GWM) 130 acts as a gateway to receive or send data from a multitude of in-vehicle modules. GWM 130 receives or sends signal 119 from infotainment system network 110. In some configurations, the GWM 130 may be bypassed.

The network 140, independent of infotainment network 110 and GWM 130, includes a Powertrain Module (PCM) 142, Body Control Module (BCM) 144 and Transmission Control Module (TCM) 146. Function of network 140 will control pulse signal, voltage, current or amperage, with additional capability to recognize when vehicle engine is on or off, the speed of vehicle and transmission gear the vehicle is in when the emergency lighting and siren are activated. In one embodiment, the PCM 142 communicates signal 147 to the GWM 130, which then communicates data via signal 119 to any of the embodiments as seen in Network 110. In another embodiment, the BCM 144 communicates signal 147 to the GWM 130, which then communicates data via signal 119 to any of the embodiments as seen in network 110. In yet another embodiment the TCM 146 communicates data via signal 147 to the GWM 130, which then communicates signal 119 to any of the embodiments as seen in network 110. In yet another embodiment the PCM 142 communicates to the BCM 144 and both or one of the modules communicates data via signal 147 to the GWM 130, which then communicates data via signal 119 to any of to any of the embodiments as seen in network 110. In yet another embodiment the TCM 146 communicates to the BCM 144 and both or one of the modules communicates data via signal 147 to the GWM 130, which then communicates data via signal 119 to any of to any of the embodiments as seen in network 110. In yet another embodiment, both the PCM 142, BCM 144 and TCM 146 communicate directly to each other and both or one of the modules communicates data via signal 147 to the GWM 130, which then communicates data via signal 119 to any of to any of the embodiments as seen in infotainment system network 110. In yet another embodiment the PCM 142 and TCM 146 communicate directly to each other and both or one of the modules communicates data via signal 147 to the GWM 130, which then communicates data via signal 119 to any of to any of the embodiments as seen in infotainment system network 110.

Antenna 150 includes any embodiment of a singular or plurality of in-vehicle antenna(s) including GPS, Cellular, PCS, WI-FI or Satellite. Antenna 150 receives GPS, Cellular, PCS, Wi-Fi or Satellite data via signal 151 and transmits that data via signal 131 to the GWM 130 for any and all embodiments included from networks 110 or 120.

The network 160 includes an exemplary system that facilitates a method to transmit or receive data into the vehicles antenna(s) 150 via input signal 151. The network 160 includes an array of transmitters including a Satellite 162, Wi-Fi 164 and Cell Tower 166. In one embodiment the data from network 160 will be transmitted or received from a Satellite transmitter 162 directly onto the vehicle antenna 150 via input signal 151. In another embodiment the data from network 160 will be transmitted or received from external Wi-Fi transmitter 164 directly onto the vehicle antenna 150 via input signal 151. In yet another embodiment the data from network 160 will be transmitted or received from Cell Tower 166 directly to a vehicle antenna 150 via input signal 151. In yet another embodiment the data from network 160 will be transmitted or received in conjunction with a plurality of transmitters or receivers including Satellite Antenna 162, external Wi-Fi Antenna 164 and Cell Tower 166 directly to the vehicle antenna 150 via input signal 151.

Cloud server 170 is an external remote device responsible updating the In-vehicle Emergency Lighting and Siren Application. When changes occur to the Emergency Lighting and Siren Application such as, but not limited to addition of new light bars, GUI updates, new LED light locations, changes to siren sounds, new siren and or LED light makes, models or brands, the Cloud Server 170 will wirelessly update the Infotainment System Network 110, from over-the-air updates from a Wi-Fi, satellite or cellular download.

Network 190 includes any and all emergency lights 194 and siren 192 equipped on the vehicle. Data transmitted by networks 100, 110, 120, 130 and 140 via output signal 191 for operation of emergency lighting and siren.

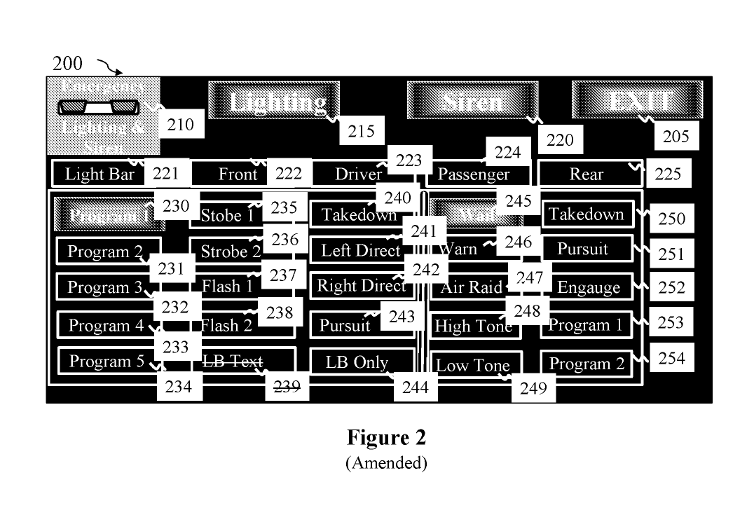

Referring now to FIG. 2, a mockup 200 of a GUI for an infotainment system using the Home screen of the Emergency Lighting and Siren Application. Home screen of the Emergency Lighting and Siren Application 200 has a single touch EXIT button 205, atop the right hand side of the display interface. The Emergency Lighting & Siren Icon 210 with Light Bar image, in the upper left hand corner of the GUI, is also a visual reminder denoting user is using the Emergency Lighting and Siren Application Home screen 200. Atop the center of the GUI are the Lighting 215 and Siren 220 buttons. Each of these buttons are single touch and can be selected to edit Lighting and Siren options. Below the Lighting 215 and Siren 220 buttons are single touch buttons for individual lighting menus, to control individual lights as seen in exterior vehicle views including Light Bar 221, Front (vehicle) 222, Driver (side vehicle) 223, Passenger (side vehicle) 224 and Rear (vehicle) 225. Lighting button 215 illuminates when any of the exterior vehicle menus 221, 222, 223, 224 or 225 have been selected. Below the exterior vehicle menus include programmable and pre-set lighting functions including, but not limited to user programmable options Program 1 230, Program 2 231, Program 3 232, Program 4 233, Program 5 234 as well as pre-program controlled functions Strobe 1 235, Strobe 2 236, Flash 1 237, Flash 2 238, Takedown 240, Left Direct[ional] 241, Right Direct[ional] 242, Pursuit 243 and LB (Light Bar) Only 244. Also, below the exterior vehicle menus include, but are not limited to, programmable and pre-set siren functions Wail 245, Warn 246, Air Raid 247, High Tone 248, Low Tone 249, Takedown 250, Pursuit 251, Engage 252, Program 1 253 and Program 2 254.

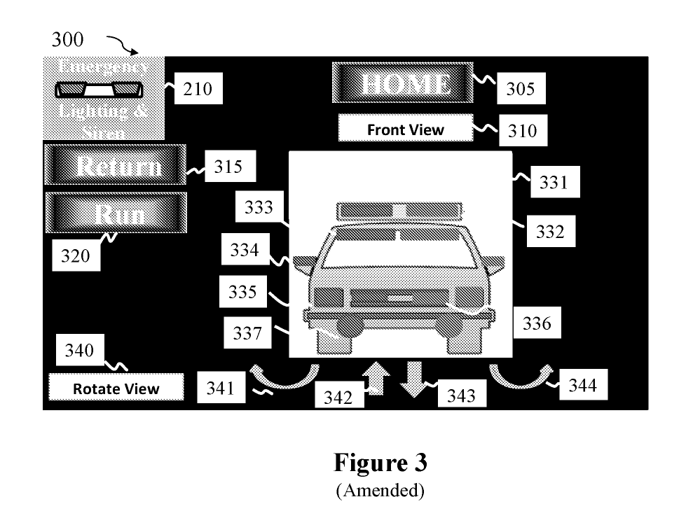

Referring now to FIG. 3, a mockup 300 of a GUI for an infotainment system using the Emergency Lighting and Siren Application 101 is displayed. Emergency Lighting and Siren Application 101 allows for adjusting individual lights as viewed from the front view, Driver (RH) View, Rear View, Top View and Passenger (LH) View. The Emergency Lighting and Siren Icon 210 is displayed in the upper left-hand corner of the infotainment system GUI, indicating that the user is in the appropriate menu to adjust the emergency lighting. To the right of the Emergency Lighting and Siren Icon 210 is the Home button 305. A text display interface indicating the positioning and Front View 310 of the emergency lighting equipment on the vehicle is displayed. Included in the GUI is the Return button 315 allowing the user to return to the multi-media user interface display and exiting from the In-vehicle Emergency Lighting and Siren Application 101 and the Run button 320 allowing the user to display the current vehicle lighting, flash patterns, lighting sequence and other options as it would appear from outside the vehicle in real time. Below the Front View text display 310 is an interactive image of the vehicle 331 equipped with all emergency lighting. A single touch to the GUI of any of the lights equipped on the vehicle will open up a separate lighting menu, where each light can be individually turned on or off, adjustments to lighting flash patterns, changes to light color, changes to light directional indicators or other such changes can occur. Emergency light bar 332, vehicle visor lights 333, side mirror or skull cap lights 334, strobe, turn and park headlights 335, grille lights 336 and fog lights 337 can all be adjusted from the front view. Below the image and in the lower left-hand side of the user interface is the text Rotate View 340. Directly to the right and below the front view image is the driver side or left-hand (LH) side view 341 arrow, the top view arrow 342, bottom view arrow 343 and the passenger side or right-hand RH side view 344.

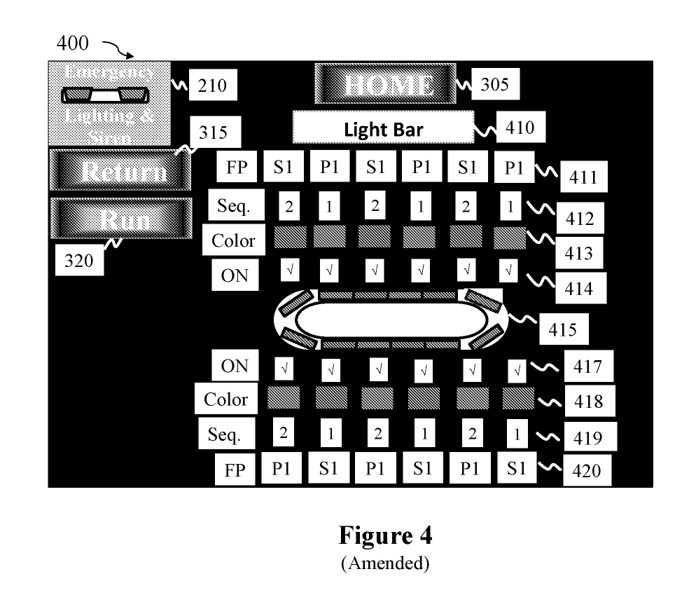

Referring now to FIG. 4, a mockup 400 of a GUI for an infotainment system using the Emergency Lighting and Siren Application 101 with detailed light bar configuration display. Emergency Lighting Icon 210 is displayed in the upper left hand corner of the infotainment system user interface. To the right of the Emergency Lighting and Siren Icon 210 is the Home button 305. Included in the GUI is the Return button 315, which allows the user to return to the multi-media GUI display by exiting from the Emergency Lighting and Siren Application 101. The Run button 320 allows the user to display the current vehicle lighting, flash patterns, sequence and other options as it would appear from outside the vehicle in real time. A text display interface, indicating the type of emergency Light Bar 410 to be adjusted is indicated. Below the text indicating the Light Bar 410 are controls for the individual LED lights in the light bar, as seen from the top view, right hand vehicle side from the forward facing vehicle view. Light bar options for lighting controls include Flash Pattern (FP) 411 display, which allows for adjusting lighting flash patterns for each individual light included in the light bar. Functionality includes, but is not limited to strobe, pulse, on (no flash). Within each of the aforementioned functions includes a myriad of different flash patterns. These single touch selectable fields include a row of selectable Flash Patterns (FP) 411 for each individual light within the light bar, which can be adjusted to any available preset flash pattern. Pre-set flash patterns can contain multiple patterns for each unique type of flash pattern such as strobe 1, strobe 2, strobe 3, pulse 1, pulse 2, pulse 3, etc. The order in which the lights cycle through their flash pattern are also adjusted from the sequence row 412. Sequence numbers are sequential and initiate the sequential pattern in which the lights cycle through their flash pattern. Color row 413 adjusts color of LED lights and can be adjusted by a single touch. The left hand side from vehicle view, On row 414, simply indicates that the LED light with the flash pattern is turned on by a single touch and is noted by the visual indicator √. The LED light bar 415 is depicted by a visual display of the light bar. By selecting the Run button 320, the LED light bar 415 will run through a series of LED functionality like flash pattern, sequence or color. Below the LED light bar 415 are the opposite side LEDs, Left Hand (LH) side from vehicle view, On row 417, color row 418, sequence row 419 and flash pattern 420.

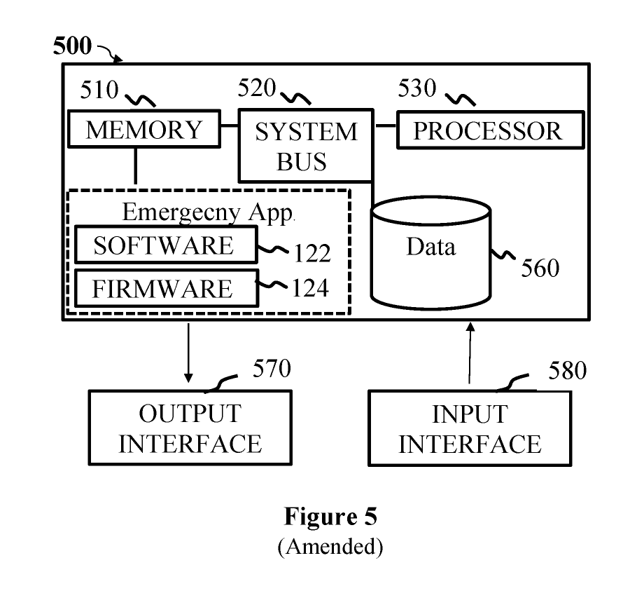

Referring now to FIG. 5, an illustration of an exemplary computing device 500 that can be used in accordance with the systems and methodologies disclosed herein is illustrated. The computing device 500 includes memory 510 which executes stored instructions for implanting functionality described as being carried out by one or more components discussed above. Data received from the system bus 520 is processed by at least one processor 530 that executes instructions that are stored in memory 510. Instructions for implementing functionality described as being carried out by one or more components discussed above or instructions for one or more of the methods described above that are carried out by either the Emergency Lighting and Siren software 122 or firmware 124. The computing device 500 additionally includes a data storage 560 that is accessible by the processor 530 through the system bus 520. The data storage 560 may include executable instructions. The computing device 500 also includes an input interface 580 that allows external devices to communicate with the computing device 500. For instance, the input interface 580 may be used to receive instructions from an external computer device, from a user, etc. The computing device 500 also includes an output interface 570 that interfaces the computing device 500 with one or more external devices. For example, the computing device 500 displays the Emergency Lighting and Siren Application 101 by way of the output interface 570.

It is contemplated that the external devices that communicate with the computing device 500 via the input interface 580 and the output interface 570 can be included in an environment that provides substantially any type of user interface with which a user can interact. Examples of user interface types include GUI, natural user interfaces, and so forth. For instance, a GUI may accept input from a user employing input device(s) such as a keyboard, mouse, remote control, or the like and provide output on an output device such as a display. Further, a natural user interface may enable a user to interact with the computing device 500 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for instance, several devices may be in communication by way of a network connection and may collectively perform tasks described as being performed by the computing device 500.

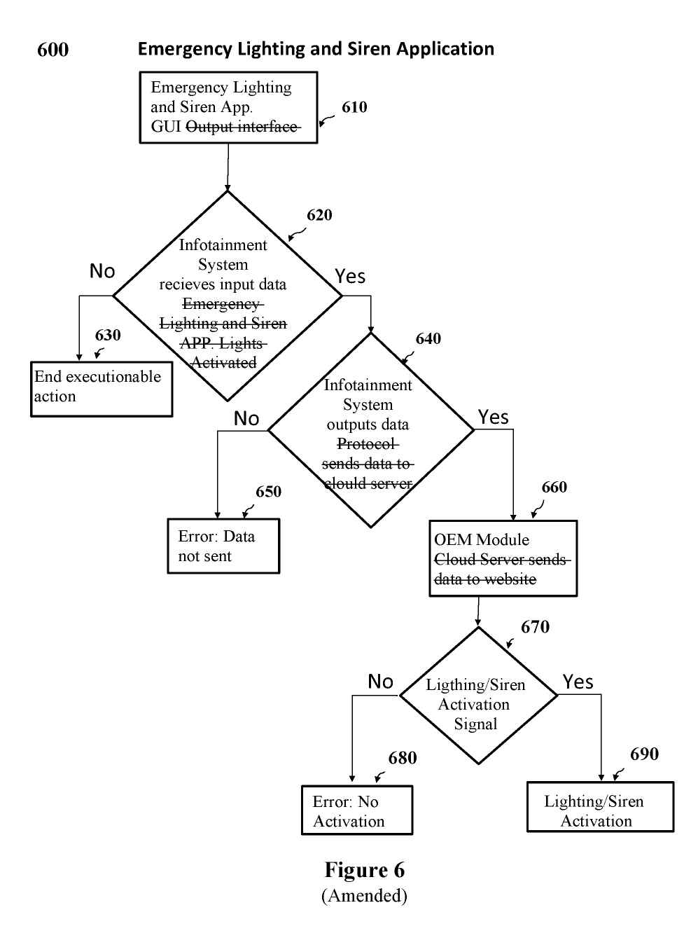

FIG. 6 is an improved methodology 600 that facilitates the activation and control of a vehicle's emergency lighting and siren from inputs received by the In-vehicle Infotainment System Emergency Lighting and Siren Application GUI 610. The methodology starts at the Emergency Lighting and Siren Application GUI 610. The methodology transitions to the Infotainment System receiving user input data 620 from the In-vehicle Infotainment System Emergency Lighting and Siren Application GUI 610. If data is not received from the GUI, the executional action will be ended 630 with no action taken. If data is received, methodology will transition to the Infotainment System outputting data 640. If no output data is detected, the Infotainment System network 110 will display Error: Data not sent 650. If the output data is received, the methodology may transition from the Infotainment System output data 640 to an OEM module 660 such as GWM 130, PCM 142, BCM 144, TCM 146 or any other OEM module operating on the vehicle's CAN bus network. In another embodiment, the methodology may transition from Infotainment system output data 640, bypassing an OEM module 660, and directly to a data activation signal of the Lighting and Siren 670. From the Lighting and Siren Activation signal 670, the methodology will transition, if no signal is detected, the Infotainment System network 110 will display Error: No Activation 680. If signal is present, Lighting or Siren activation 690 will occur.

While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Plurality of in-vehicle communication networks pre-existing in vehicle including CAN bus networks designed with multiplex electrical wiring, allowing in-vehicle microcontrollers and modules to communicate between each other exist in a multitude of embodiments. Local Interconnect Network (LIN) operating on 1 Kbps to 20 Kbps. High Speed CAN (HSCAN) operating between 125 Kbps and 500 Kbps. Low Speed CAN (LSCAN) operating between 40 Kbps and 125 Kbps. Infotainment CAN (InfoCAN) operating from a transfer speed of both 40 Kbps to 125 Kbps or 125 Kbps to 500 Kbps, when paired to other in-vehicle microcontrollers or transfer speeds ranging from 1 Kbps to 11 Gbps on a cellular network or 11 Mbps to 7,000 Mbps operating on Wi-Fi, with speeds falling under Wi-Fi standards 802.11b, 802.11a, 802.11g, 802.11n or 802.11ac.

Various functions described herein can be implemented in hardware, software, or any combination thereof If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system, comprising:
an In-vehicle Infotainment System Emergency Lighting and Siren Application for use on an in-vehicle infotainment system with a plurality of input signals transmitted over any combination of in-vehicle communication networks including, but not limited to Local Interconnect Network (LIN), High Speed CAN (HSCAN), Low Speed CAN (LSCAN), Infotainment CAN (InfoCAN) or any other CAN bus network:
an Audio and Video Control Module coupled to the plurality of input signals, the Audio and Video Control Module configured to receive user input;
a Touchscreen or Touchscreen Module, the Touchscreen Module configured to respond to the user input, the user input selecting from one of the plurality of input signals;
a Vehicle Radio, the Touchscreen or Touchscreen Module configured to respond to the user input, the user input selecting from one of the plurality of input signals;
a Gateway Module, the Gateway Module coupled to the Audio and Video Control Module, Touchscreen or Touchscreen Module or Vehicle Radio, the Gateway Module configured to receive a user data; and
an antenna module, the antenna module coupled to the Gateway Module, Vehicle Radio, Audio and Video Module, or Touchscreen to the antenna module configured to transmit the user data to a cellular tower;

2. The system of claim 1, further comprising software or firmware capable of adjusting light patterns, changing light color, changing light directional patterns, adjusting light level, changing light flash patterns, changing light flash sequences, changing siren sounds and siren volume.

3. The system of claim 2, further comprising controlling all emergency lighting, including light bars, quarter lighting, strobe lights, park lights, turn lights, spotlights, fog lights, license plate lights, fender lights, tailgate lights, dome lights, visor lights.

4. The system of claim 2, further comprising all emergency sirens, amplifiers or microphones mounted to the vehicle.

5-13. (canceled)
